(19) United States
(12) Patent Application Publication
(10) Pub. No.: US 2026/0295894 A1
(43) Pub. Date: Oct. 1, 2026

(54) Circular Saw

(71) Applicant: Festool GmbH, Wendlingen am Neckar (DE)

(72) Inventors: Martin Werbach, Stuttgart (DE); Alexander Lautenschläger, Esslingen (DE); Björn Scherraus, Filderstadt (DE)

(21) Appl. No.: 19/476,427

(22) PCT Filed: May 3, 2024
(86) PCT No.: PCT/EP2024/062185

§ 371 Date: Oct. 17, 2025

(30) Foreign Application Priority Data
May 22, 2023 (DE) 10 2023 113 260.1

(51) Int. Cl. B27G 19/02; B27G 19/04

(52) U.S. Cl. CPC B27G 19/025; B27G 19/04

(57) ABSTRACT

The invention relates to a circular saw having a saw head (40), which accommodates a drive unit (47) having a drive shaft (47.1), wherein the drive shaft (47.1) is rotatably mounted on the saw head (40) by means of a shaft bearing (47.2), wherein the drive shaft (47.1) bears a saw-blade holder (45), on which a saw blade (46) can be interchangeably mounted, wherein a saw-blade receptacle (45.6) is provided, which is designed to receive the saw blade (46) that is detachably mounted on the saw-blade holder (45), wherein the saw-blade receptacle (45.6) has an inner receptacle face (45.7) and an outer receptacle face (45.8) spaced apart from the inner receptacle face (45.7) in the direction of the axis of rotation of the drive shaft (47.1), wherein the inner receptacle face (45.7) faces the shaft bearing (47.2) and the outer receptacle face (45.8) is disposed facing away from the shaft bearing (47.2) in the direction of the axis of rotation of the drive shaft (47.1), wherein a protective saw-blade cover is provided, which blocks access to the saw-blade receptacle (45.6), in particular to the saw blade (46) held in the saw-blade receptacle (45.6), at least sectionally, wherein the protective saw-blade cover has a movable saw-blade cover (60), which can be swiveled between a closed protective position and an open sawing position relative to the saw head (40) by means of a protective-cover bearing arrangement and which is designed and disposed to cover a saw blade (46) mounted in or at the saw-blade receptacle (45.6) at its circumferential cutting area (46.1) in the closed protective position, at least sectionally. To achieve an improved force transmission from the saw blade into the drive shaft and the shaft bearing in such a circular saw, provision is made according to the invention for the saw-blade holder (45) to be disposed between the protective-cover bearing arrangement and the shaft bearing (47.1) of the drive shaft (47.1).

A circular saw having a saw head, which accommodates a drive unit having a drive shaft, wherein the drive shaft is rotatably mounted on the saw head by means of a shaft bearing, wherein the drive shaft bears a saw-blade holder, on which a saw blade can be interchangeably mounted, wherein a saw-blade receptacle is provided, which is designed to receive the saw blade that is detachably mounted on the saw-blade holder, wherein the saw-blade receptacle has an inner receptacle face and an outer receptacle face spaced apart from the inner receptacle face in the direction of the axis of rotation of the drive shaft, wherein the inner receptacle face faces the shaft bearing and the outer receptacle face is disposed facing away from the shaft bearing in the direction of the axis of rotation of the drive shaft, wherein a protective saw-blade cover is provided, which blocks access to the saw-blade receptacle, in particular to the saw blade held in the saw-blade receptacle, at least sectionally, wherein the protective saw-blade cover has a movable saw-blade cover, which can be swiveled between a closed protective position and an open sawing position relative to the saw head by means of a protective-cover bearing arrangement and which is designed and disposed to cover a saw blade mounted in the saw-blade receptacle at its circumferential cutting area in the area of a cutting section of the saw in the closed protective position, at least sectionally. The cutting section of the saw refers to the area of a saw blade that can be installed in the saw-blade receptacle and that meshes with the workpiece during processing.

Circular saws according to the invention can be, in particular, mobile or semi-stationary circular saws, which are brought to an installation site by a user and used there. Accordingly, circular saws according to the invention can be miter saws, sliding compound miter saws or regular hand-held circular saws.

In the case of circular saws according to the invention, the saw head may be swivel-mounted about a swivel axis, which may, for instance, extend in parallel to the axis of rotation of the saw-blade holder and may preferably form a miter axis.

In circular saws according to the invention, a saw blade is held on a rotatable saw-blade holder. A protective saw-blade cover is assigned to the saw blade. The former comprises a fixed protective saw-blade cover and a movable saw-blade cover swivel-connected to the saw head.

The movable saw-blade cover can be swiveled between a closed protective position and an open or partially open sawing position. In the closed protective position, the movable saw-blade cover covers the cutting section of a saw blade housed in the saw-blade receptacle of the saw head. If the movable saw-blade cover is swiveled towards the open or partially open sawing position, it unblocks part of the cutting section of the saw blade. This unblocked area can be used to make a saw cut in a workpiece.

DE 10 2016 109 375 A1 discloses a miter saw that has a saw head having a saw-blade receptacle.

Functionalities are being increasingly integrated into modern circular saws. For instance, braking systems can be provided that bring the saw blade to a standstill in fractions of a second if a user enters the cutting area of the saw blade. The abrupt braking effect introduces a high load into the saw blade and via the saw blade into the drive shaft and the shaft bearing.

The invention therefore addresses the problem of creating a circular saw of the type mentioned at the beginning, which can achieve an improved transmission of force from the saw blade to the drive shaft and the shaft bearing.

This problem is solved by the saw-blade holder being disposed between the protective-cover bearing arrangement and the shaft bearing of the drive shaft. In particular, according to the invention, provision may be made for the saw-blade holder to be disposed in the axial direction of the drive shaft between the protective-cover bearing arrangement and the shaft bearing of the drive shaft.

This problem is also solved in that the saw blade mounting area is disposed in the axial direction of the drive shaft in a spacer area of at most two bearing widths of the shaft bearing of the drive shaft from the shaft bearing of the drive shaft. In particular, according to the invention, provision may be made for the saw blade mounting area to be disposed in the axial direction of the drive shaft within a spacer area of at most one bearing width of the shaft bearing of the drive shaft from the bearing of the shaft bearing.

This problem is also solved in that the saw blade mounting area is disposed in the axial direction of the drive shaft in a spacer area of less than half the bearing diameter of the drive shaft from the bearing of the drive shaft and/or the protective-cover bearing arrangement is disposed in the axial direction of the drive shaft in a spacer area of less than one bearing diameter of the drive shaft from the bearing of the drive shaft.

In known circular saws, the protective-cover bearing arrangement is usually disposed on the inner face of the saw blade facing the shaft bearing. The invention now takes a different approach by moving the protective-cover bearing arrangement to the outside of the saw blade. This permits the saw-blade holder and thus also the saw blade to be brought close to the shaft bearing in the direction of the axis of rotation. This results in a shorter moment arm between the saw blade or the saw-blade holder and the shaft bearing. This leads to a considerable reduction in the bending stress on the drive shaft. This also results in improved force transfer into the shaft bearing. The circular saw according to the invention is thus significantly more resilient, which is particularly advantageous if it is equipped with a braking device acting on the saw blade.

A stable fastening of the protective-cover bearing arrangement is achieved in a simple manner if provision is made for a support to be fastened to the saw head, which support bears the protective-cover bearing arrangement and which is disposed at least partially spaced apart from the outer receptacle face in an outer area of the saw head, wherein this outer area of the saw head is disposed laterally on the outer receptacle face facing away from the shaft bearing in the direction of the axis of rotation of the drive shaft. The outer area of the saw head can be disposed inside a housing of the saw or outside of the housing.

According to a preferred variant of the invention, provision may be made for the support to have a bearing holder, on which a bearing is held, wherein the axis of rotation of the bearing extends in parallel, preferably in alignment, with the axis of rotation of the drive shaft, and for at least part of the movable saw-blade cover to be swivel-coupled to the support by means of the bearing. In this way, the motion kinematics of the movable saw-blade cover can be adapted to the geometry of the saw blade. In addition, simple bearings can then be used for the design of the protective-cover bearing arrangement. If the axis of rotation of the bearing is in alignment (or almost in alignment) with the axis of rotation of the drive shaft, this results in a compact design for the movable saw-blade cover and simple pivot bearings, for instance roller bearings or plain bearings, can be used as bearings of the movable saw-blade cover.

A possible variant of the invention can be such that a spacer area is formed between the protective-cover bearing arrangement and the inner receptacle face of the saw-blade receptacle, in particular between the protective-cover bearing arrangement and a saw-blade support surface of the saw-blade holder, which spacer area is accessible radially to the axis of rotation of the saw-blade holder. The saw blade can be easily fitted or removed via the radially accessible spacer area. In other words, a gap extending in the axial direction of the drive shaft is formed between the saw-blade receptacle and the protective-cover bearing arrangement, through which gap the saw blade can be removed in a radial direction relative to the drive shaft.

Preferably, provision may also be made for a clamping piece for clamping the saw blade to the saw-blade holder to be disposed at least sectionally in the spacer area between the protective-cover bearing arrangement and the outer receptacle face, and for the saw-blade holder to be formed between the saw-blade holder and the clamping piece. In particular for easy assembly/disassembly of the saw blade, provision may be made for the clamping piece, in particular a tool holder of the clamping piece, to be accessible through an access area of the protective-cover bearing arrangement, preferably in the axial direction of the drive shaft.

In the context of the invention, the bearing arrangement may also have a lead-through, through which a fastening element, in particular a fastening screw, can be guided for fastening the saw blade to the saw-blade holder. The fastening element can be used, for instance, to connect the clamping piece to the drive shaft for fastening the saw blade. Preferably, the lead-through may extend aligned with the axis of rotation of the drive shaft.

A conceivable variant of the invention can be such that the movable saw-blade cover has a first cover segment and a second cover segment, which in the closed protective position each cover a partial area of the saw-blade receptacle, in particular a partial area of a saw blade mounted in the saw-blade receptacle, each and that these two cover segments can be adjusted relative to each other. In this way, the movable saw-blade cover can be swiveled into the open sawing position in a space-saving manner. Due to the reduced space requirement for the movable saw-blade cover, additional installation space is available, which can be used for a compact design of the circular saw. For instance, it is conceivable that a brake arrangement for braking the saw blade in the event of danger is installed at least sectionally inside the installation space that is an extension of the swivel motion of the movable saw-blade cover. Preferably, the support can accommodate the two cover segments in a rotatable manner.

A space-saving and at the same time simple design is achieved if provision is made for the bearing holder of the support to be of annular design and for the bearing holder to bear the/a bearing for mounting the first cover segment on its inner circumference and a bearing part for mounting the second cover segment on its outer circumference. If, according to a variant of the invention, provision is made for the first cover segment to have a guide, which interacts with a guide element of the second cover segment to form a sliding guide, and for the sliding guide to guide the adjusting motion of the two cover segments relative to each other, then an operationally reliable adjustment of the two cover segments relative to each other can be guaranteed. Preferably the adjusting motion of the two cover segments relative to each other may be delimited in at least one adjusting direction by a delimiting element to rule out possible operating errors.

If provision is made for the movable saw-blade cover to have at least one cover section, for the cover section to cover an area of the saw-blade receptacle, in particular an area of the saw blade, in the closed protective position, and for the cover section to be preferably interchangeably connected to the bearing arrangement, the entire movable saw-blade cover does not have to be replaced in the event of damage or wear. Instead, it is sufficient to only replace the damaged cover section.

The invention is explained in greater detail below based on an exemplary embodiment shown in the drawings. In the figures,

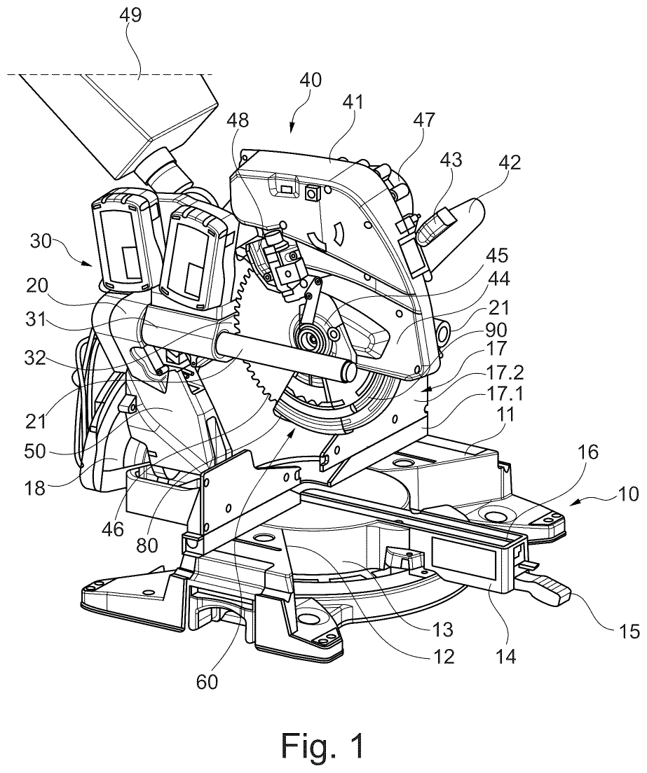

FIG. 1 shows a perspective view of a circular saw designed as a sliding compound miter saw,

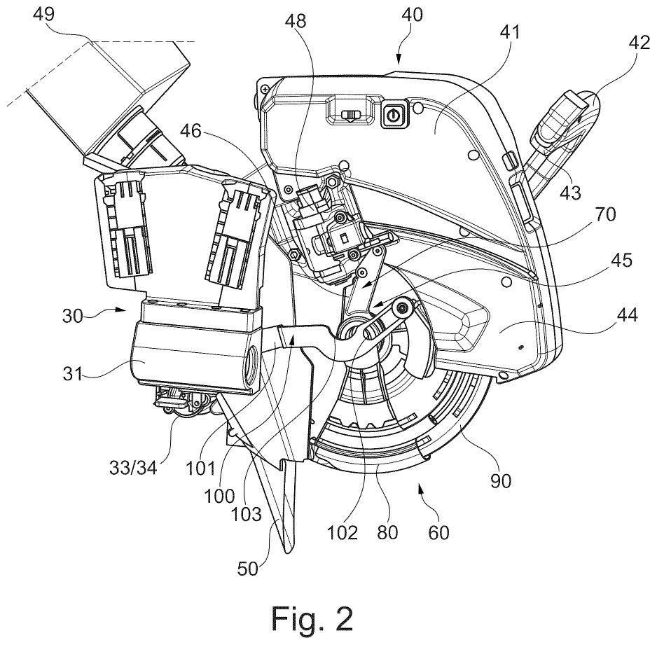

FIG. 2 shows a perspective view of an assembly of the circular saw of FIG. 1,

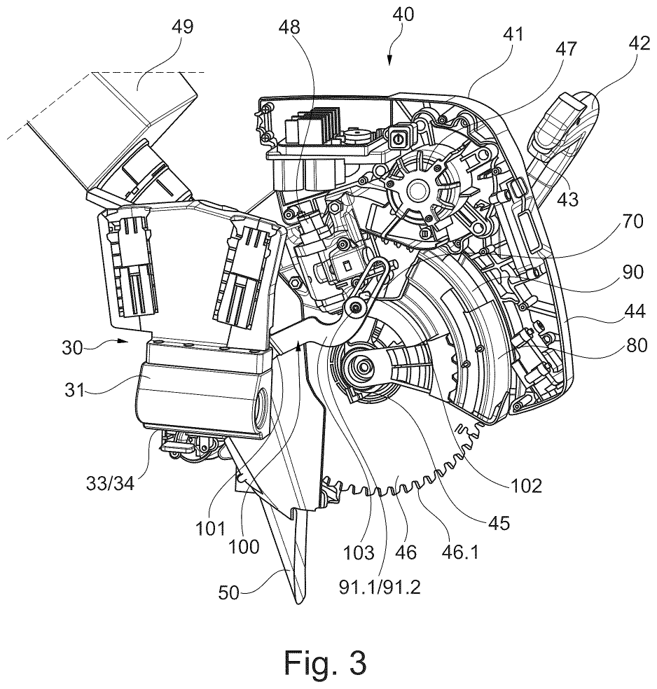

FIG. 3 shows a partially sectioned view of the representation of FIG. 2,

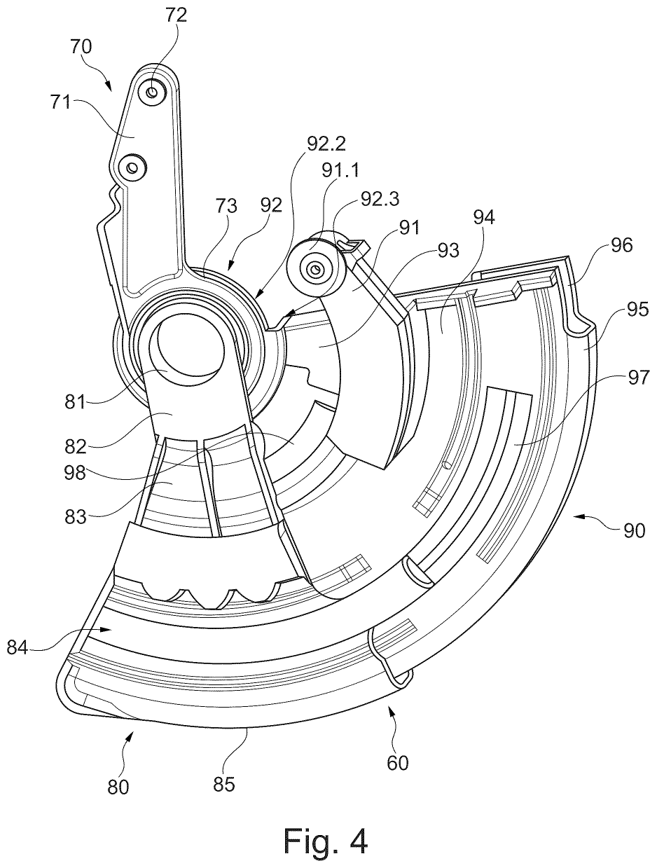

FIG. 4 shows a protective saw-blade cover of the circular saw of FIGS. 1 to 3,

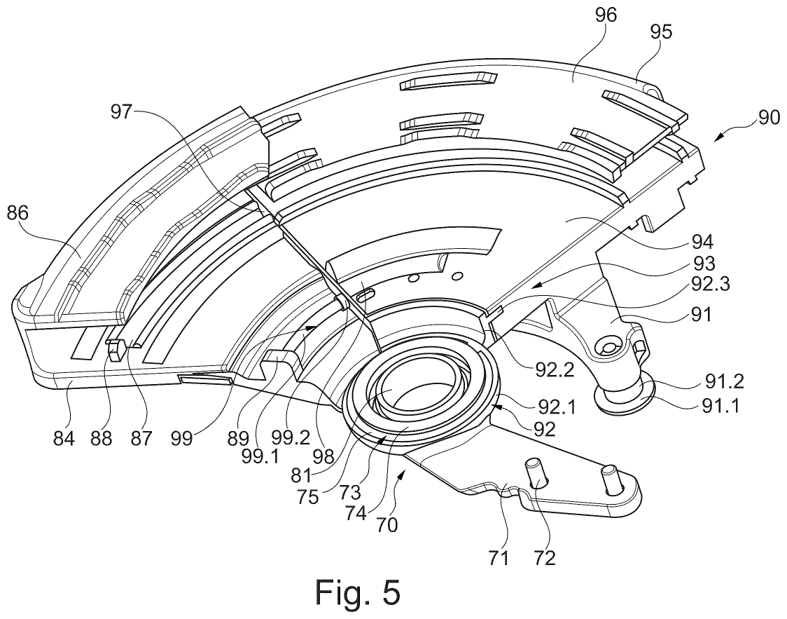

FIG. 5 shows the protective saw-blade cover of FIG. 4 from a different perspective,

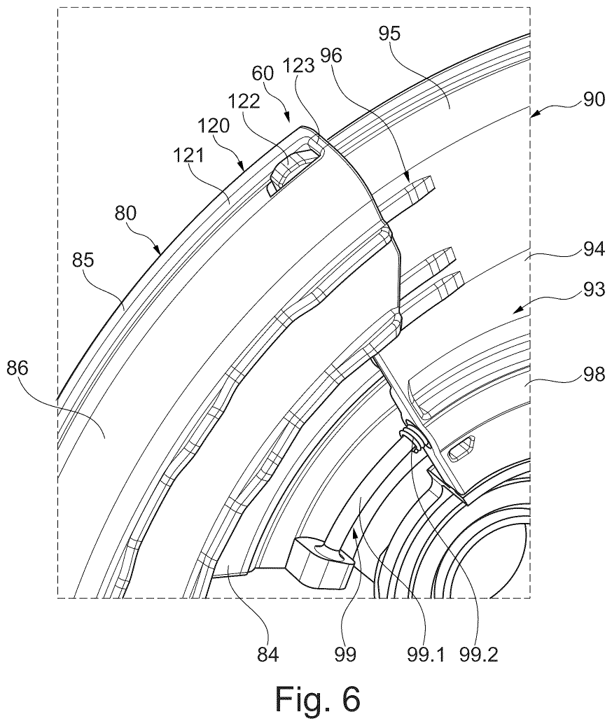

FIG. 6 shows a detail of the protective saw-blade cover of FIGS. 4 and 5,

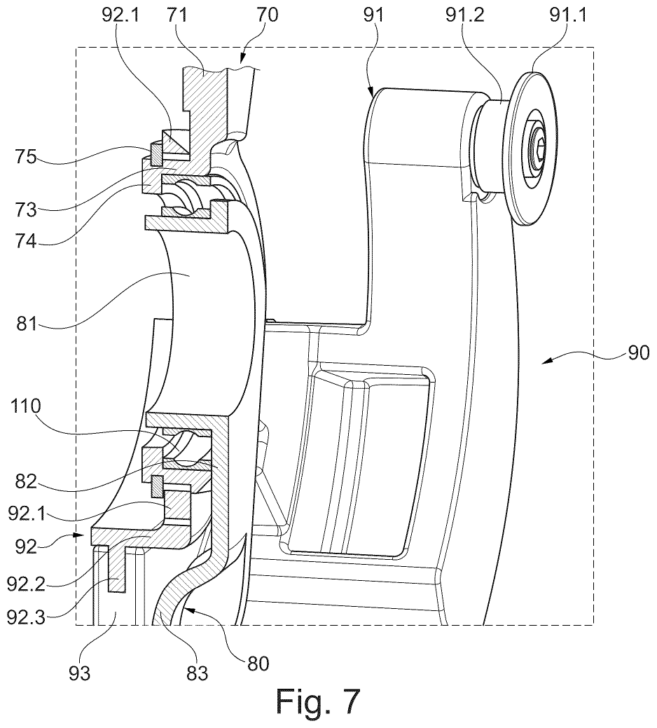

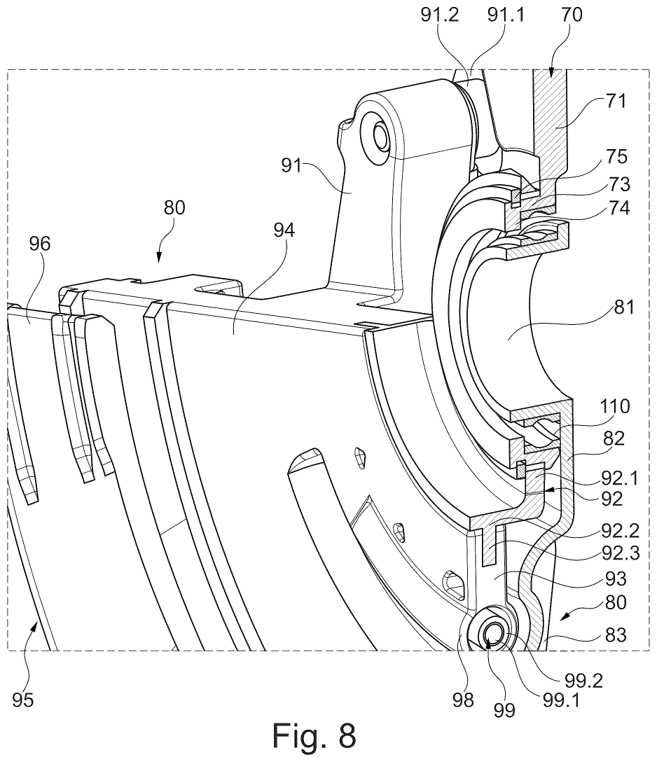

FIGS. 7 and 8 show a further detail of the protective saw-blade cover of FIGS. 4 to 6 and

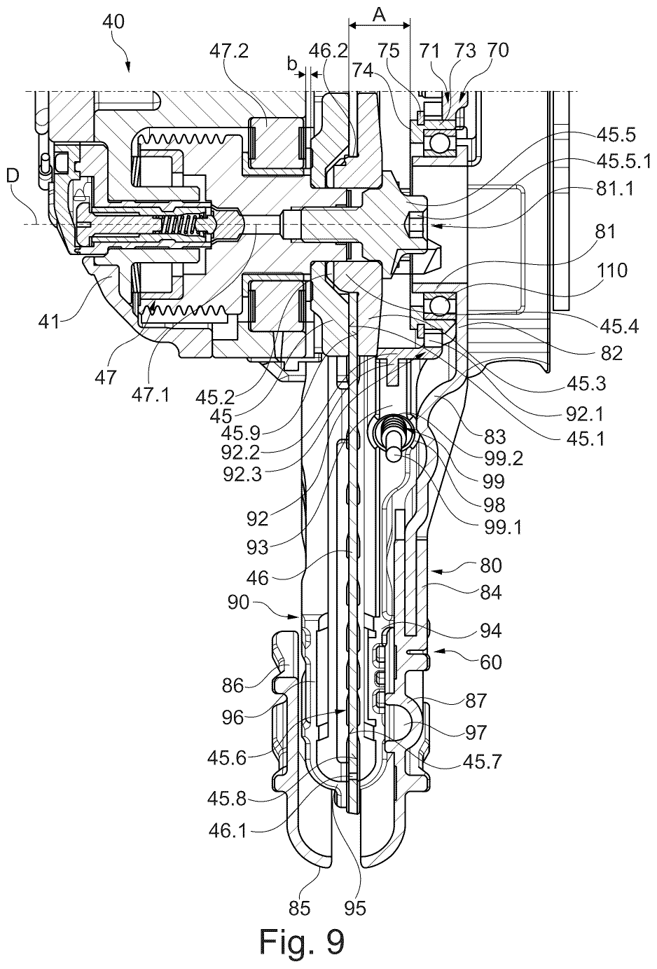

FIG. 9 shows a detailed representation of the circular saw in vertical section.

FIG. 1 shows a circular saw, in this case a sliding compound miter saw. This circular saw has a machine bed 10, whose feet can be used to place it on a work surface. The machine bed 10 has a bearing part 12, which has a support section for a swivel device 13. The swivel device 13 can be swiveled about a vertical swivel axis in the bearing part 12, rendering miter cuts with the circular saw possible. A scale is also provided in the area of the support section, which scale has an angular graduation to be able to set the desired swivel position of the swivel device 13.

The machine bed 10 and the swivel device 13 form support surfaces 11, which are interaligned on a plane. Two lateral stop pieces 17.1 of stops 17, which stop pieces can be extended in the vertical direction by means of stop plates 17.2, are mounted on the machine bed 10.

The stops 17 are used to bring a workpiece to be machined into contact, wherein the rear end of the workpiece can be brought into contact with the stop pieces 17.1 or the stop extensions 17.2.

At the front of the swivel device 13 there is a cantilever arm 14, which bears a locking device 15 at its longitudinal end, comprising a clamping operating element and a snap operating element. The swivel device 13 can be swiveled about its vertical swivel axis between secured snap positions. To release the snap connection in a snap position, the swivel device 13 has to be unlocked by means of the snap operating element. The swivel device 13 can be swiveled in an infinitely variable manner between the snap positions. A clamp connection is used to secure the swivel device 13 in an intermediate position. The clamped operating element can be used to release this clamp connection.

The circular saw has a saw slot 16, which, as in this exemplary embodiment, can extend in the area of the swivel device 13 and there, for instance, is extended into the area of the cantilever arm 14.

Delimiting rims delimit the saw slot 16 on both ends. Support surfaces 11 of the delimiting rims extend at both ends of the saw slot 16, respectively. A sawdust guide element 50 can be provided in the direction of the stops 17 adjacent to the saw slot 16, by means of which sawdust guide element sawdust can be discharged from the working area of the circular saw.

FIG. 1 further shows that the circular saw comprises a support 18 coupled to the machine bed 10 by a base via a swivel bearing having a horizontal swivel axis. The support 18 bears a head 20 that is supported by a swivel guide on a bearing housing of the machine bed 10. The swivel motion of the support 18 can be guided in the area of this support and the set position can be secured in relation to the bearing housing. A scale is provided on the bearing housing, where the swivel position can be read. The swivel positions of the support 18 relative to the bearing housing can, for instance, be adjusted using a coupling, in particular a gearing, wherein the swiveled position can be achieved by means of an adjustment device on the operator end.

FIG. 1 further shows that in the area of the head 20 the support 18 has linear guide elements 21, which extend in the direction of the saw slot 16 and that guide a saw carriage 30 in that direction in a linear manner. For this purpose, the saw carriage 30 has a base body, on which linear bearing elements 31 are disposed, which interact with the linear guide elements 21 of the support 18 to form the linear guide. The linear bearing elements are firmly interconnected by means of a connecting section 32 formed by the head 20.

A saw head 40 is attached to a carriage support 33 (see FIGS. 2 and 3) of the saw carriage 30 via a miter bearing 34 having a horizontal swivel axis. The saw head 40 has a housing 41 having a fixed protective saw-blade cover 44. A saw blade 46 is disposed below the housing 41. In the starting position shown in FIG. 1, the saw blade 46 of the circular saw is additionally covered with a movable saw-blade cover 60 on its underside.

The housing 41 has a handle 42 with a switch 43. The switch 43 can be used to activate the circular saw. At the handle 42, the saw head 40 can be swiveled relative to the carriage support 33 about the horizontal swivel axis of the miter bearing 34 such that the saw blade 46 can enter the saw slot 16, wherein the movable protective saw-blade cover 60 opens to unblock the saw blade 46. In addition, the saw blade 46 can be adjusted in conjunction with the saw head 40 in the longitudinal direction of the saw slot 16. To this end, the saw head 40 is moved along the linear guide elements 21 of the support 18. In so doing, a separating cut may be made in a workpiece.

FIG. 9 illustrates that a drive unit 47 having a drive shaft 47.1 can be installed inside the housing 41 of the saw head 40. The drive shaft 47.1 is rotatably mounted with a bearing unit about an axis of rotation D of the drive shaft 47.1. The bearing unit has a shaft bearing 47.2, which can be designed as a ball bearing, for instance.

At its end protruding from the housing 41, the drive shaft 47.1 bears a saw-blade holder 45 on a fastening section. The fastening section may form a pin-shaped end section, onto which a bore of the saw-blade holder 45 is pushed. The saw-blade holder 45 can be annular, for instance, as shown in FIG. 9. It has a saw blade contact surface 45.1, which can extend radially to the axis of rotation D of the drive shaft 47.1. In the assembled state, the saw blade contact surface 45.1 delimits a saw-blade receptacle 45.6.

The saw blade contact surface 45.1 may delimit the inner receptacle face 45.7 of the saw-blade receptacle 45.6. This is illustrated in FIG. 9.

The saw-blade holder 45 may have a recess 45.2 radially on the inside of the saw blade contact surface 45.1. This recess 45.2 is set back from the saw-blade support surface 45.1 in the direction of the shaft bearing 47.2.

A saw blade 46 can be placed in full-faced contact on the saw blade contact surface 45.1. The saw blade 46 has a central aperture 46.2, which connects to the recess 45.2 of the saw-blade holder 45. Accordingly, the inner face of the saw blade 46 rests on the saw blade contact surface 45.1.

A clamping piece 45.3 can be used to secure the saw blade 46. The clamping piece 45.3 has a spigot 45.4, which extends through the aperture 46.2 of the saw blade 46 and engages with the recess 45.2 of the saw-blade holder 45.

Facing the saw blade 46, the clamping piece 45.3 has an inner clamping surface 45.9, which rests against the outside of the saw blade 46 in the assembled state.

In the assembled state, the clamping surface 45.9 may delimit the outer receptacle face 45.8 of the saw-blade receptacle 45.6, as illustrated in FIG. 9.

A fastening element 45.5 is used to fasten the saw blade 46 to the drive shaft 47.1, which fastening element can be designed as a screw, as in this case. The fastening element 45.5 is guided through a central aperture in the clamping piece 45.3 and screwed into an axial threaded mount of the drive shaft 47.1, as shown in FIG. 9.

Tensioning the fastening element 45.4 results in the saw blade 46 being held clamped between the saw-blade holder 45 and the clamping piece 45.3. In addition, the saw-blade holder 45 is clamped against a support shoulder of the drive shaft 47.1.

FIG. 1 shows that the movable saw-blade cover 60 has a first cover segment 80 and a second cover segment 90. The two cover segments 80 and 90 can be adjusted relative to each other and relative to the saw head 40. Due to this adjustment option, the movable saw-blade cover 60 can be moved from a closed protective position, as shown in FIG. 1, to an open or partially open sawing position. In the sawing position, a cutting area 46.1 of the saw blade 46 is unblocked for a separating cut to be made in a workpiece.

As FIGS. 4 and 5 illustrate, the design can be such that the first cover segment 80 has a bearing piece 81 by means of which the first cover segment 80 can be swiveled about a swivel axis, as will be explained in more detail later.

The bearing piece 81 preferably forms a lead-through 81.1. The lead-through 81.1 is dimensioned such that the fastening element 45.5 can be pushed through the lead-through 81.

A transition section 82 is connected to the bearing piece 81, which transition section bears an outer casing 84 on an attachment piece 83. A toothing cover 85 adjoins the outer casing 84.

FIG. 5 shows that an inner cover 86 can be connected to the toothing cover 85.

The outer casing 84 forms a cover section, which, in the closed protective position of the movable saw-blade cover 60, covers a part of the outer face of the saw blade 46. Accordingly, the outer casing 84 is disposed on the side facing away from the shaft bearing 47.1 next to the outer receptacle face 45.8 of the saw-blade receptacle 45.6. Accordingly, the outer casing 84 prevents access to the outer face of the saw blade 46 in the closed protective position.

The toothing cover 85 forms a cover section, which covers the cutting area 46.1 of the saw blade 46 in the closed protective position of the movable saw-blade cover 60. Accordingly, the toothing cover 85 covers the radially outer area of the saw blade 46.1 and thus also the radially outer area of the saw-blade receptacle 45.6.

The inner cover 86 forms a cover section, which, in the closed protective position of the movable saw-blade cover 46, covers a part of the inner face of the saw blade 46. Accordingly, the inner cover 86 is disposed on the side facing the shaft bearing 47.2 next to the inner receptacle face 45.7 of the saw-blade receptacle 45.6. Accordingly, the inner cover 86 prevents access to the inner face of the saw blade 46 in the protective position.

Provision may be made for the outer casing 84, the toothing cover 85 and/or the inner cover 86 to be provided on a first cover segment 80.

FIG. 5 shows that a guide 87 may be present on the first cover segment 80. Preferably, the guide 87 is integrally connected to the first cover segment 80. In this exemplary embodiment, the guide 87 is recessed in cross-section in the form of a trough-shaped recess in the outer casing 84. Preferably, the guide 87 extends longitudinally concentrically to the swivel axis formed by the bearing piece 81.

To delimit the swiveling motion of the two cover segments 80 and 90 relative to each other, a delimiting element 88 can be provided on one of the cover segments 80, 90, which delimiting element abuts a counter-stop of the respective other cover segments 80, 90.

Advantageously, the first cover segment 80 can be bi-partite or of multi-part design. In this exemplary embodiment, the outer casing 84, the toothing cover 85 and/or the inner cover 86 form an integrally molded body, which is preferably interchangeably connected to the attachment piece 83.

The first cover segment 80 and the support 83 can be manufactured as a 2-component part, for instance made of plastic and metal, wherein the attachment piece 83 is made of metal and the molded body is made of plastic.

The second cover segment 90 has a bearing part 92.1 having a bearing 92 (see FIG. 9). A fastening section 92.3 of an attachment piece 92.2 is connected to the bearing part 92.1.

The second cover segment has a casing element 93 supporting an outer casing 94. The outer casing 94 is adjoined by a toothing cover 95 and an inner cover 96.

Similar to the first cover segment 80, the outer casing 94 forms an outer cover section, which covers the outer receptacle face 45.8 of the saw-blade receptacle 45.6 on the outside. The toothing cover 95 encompasses the cutting area 46.1 of the saw blade 46. The inner cover 96 adjoins the inner receptacle face 45.7 of the saw-blade receptacle 45.6 in the direction of the shaft bearing 47.1.

The components designed as cover sections-outer casing 94, toothing cover 95 and inner cover 96—do not have to be provided in conjunction on the second cover segment 90. Rather, the second cover segment 90 may comprise the outer casing 94, the toothing cover 95 and/or the inner cover 96 as a molded part.

The second cover segment 90 and the fastening section 92.3 can be manufactured as a 2-component part, for instance made of plastic and metal, wherein the fastening section 92.3 is made of metal and the molded part is made of plastic.

The second cover segment 90 can be designed such that it has a guide element 97. The guide element 97 is designed and disposed to form a guide in conjunction with the guide 87 of the first cover segment 80. In so doing, the guide guides the adjusting motion of the first cover segment 80 relative to the second cover segment 90.

The guide element 97 may be integrally formed on the outer casing 94, as FIG. 5 shows. Advantageously, the guide element 97 is designed as a protrusion that engages with the guide 87, which is designed as a trough-shaped depression. The protrusion can be rib-shaped and extend concentrically to the swivel axis of the second cover segment 90.

As FIGS. 7-9 show, the first cover segment 80 and/or the second cover segment 90 are swivel-mounted on a support 70. Preferably, both cover segments 80 and 90 are held on the support 70 in a swiveling manner.

The support 70 has an arm 71, which is used to attach it to the swiveling saw head 40 (see FIGS. 1-3). Preferably, the arm 71 is or can be detachably connected to the saw head 40 by means of fastening elements 72.

The support 70 may have a bearing holder 73 at the end of the arm 71. A bearing 110 for supporting the first cover segment 80 is disposed on the bearing holder 73 (see FIG. 9). The bearing 110 forms a swivel axis, about which the first cover segment 80 can swivel.

As FIG. 9 shows, the bearing 110 can preferably be designed as a rolling bearing, in particular as a ball bearing. The outer ring of the rolling bearing is inserted into the bearing holder 73 and strikes against a stop 74 of the support 70. The stop 74 is preferably molded onto the bearing holder 73. The inner ring of the rolling bearing is pushed onto the outside of the bearing piece 81, wherein the sliding motion is limited there by means of a stop, which is formed, for instance, by the transition section 82.

Additionally or alternatively, provision may be made for the second cover segment 90 to be swivel-mounted on the support 70. For this purpose, the bearing holder 73 forms a bearing mount for the bearing part 92.1 of the second cover segment 90. FIG. 7 illustrates that a plain bearing can be used to support the second cover segment 90. However, it is also conceivable that a rolling bearing is also used as the bearing of the second cover segment 90.

A securing element 75, which can be designed as a snap ring, is provided to secure the bearing part 92.1 to the bearing holder 73. The bearing holder 73 therefore has a circumferential groove into which the securing element 75 is inserted.

As the drawings show, to implement a compact size, advantageously provision is made for the two swivel bearings for the first and second cover segments 80, 90 to be arranged in succession in the radial direction.

Advantageously, the swivel axes, about which the two cover segments 80, 90 can swivel, are interaligned.

According to FIG. 9, advantageously provision is made for the axis of rotation D to be aligned with the swivel axes of the two cover segments 80, 90.

FIG. 9 further shows that the arm 71 of the support 70 extends in the direction of the axis of rotation D on the side of the saw blade 46 facing away from the shaft bearing 74.2 and thus next to the outer receptacle face 45.8 of the saw-blade receptacle 45.6. Thus, the bearing arrangement, by means of which the first and/or the second cover segment(s) 80, 90 are swivel-mounted, is also held on this side.

Preferably, the saw-blade holder 45 is disposed in the direction of the axis of rotation D between the shaft bearing 47.2 and the position arrangement for the first and/or the second cover segment(s) 80, 90. In this way, the shaft bearing 47.2 can be disposed a short distance b from the saw-blade holder 45 in the direction of the axis of rotation D and thus a short distance from the saw blade 46. On the one hand, this achieves a compact design. On the other hand, the transfer of the forces that are introduced into the drive shaft 47.1 via the saw blade 46 is improved and the bending stress on the drive shaft 47.1 can be reduced. In particular, this makes for a stress-optimized design for the drive shaft 47.1.

The distance “b” between the shaft bearing 47.2 and the saw-blade holder 45, measured in the direction of the axis of rotation D, is preferably a maximum of 3.5 millimeters, preferably a maximum of 1.5 millimeters, particularly preferably a maximum of 1 millimeter.

Additionally or alternatively, provision may also be made for the distance dimension “A” between the shaft bearing 47.2 and the saw blade support surface 45.1 of the saw-blade holder 45, measured in the direction of the axis of rotation D, to be preferably a maximum of 15 millimeters, preferably a maximum of 12 millimeters, particularly preferably a maximum of 10 millimeters.

FIG. 9 clearly shows how, in the closed protective position, the two cover segments 80, 90 protect the saw blade 46 from being accessed by a user. The cover segments 80, 90 are designed such that one cover segment 90 can be swiveled into the installation space of the other cover segment 80, resulting in a compact arrangement in the partially opened or opened sawing positions, as shown in FIG. 3.

FIG. 3 also shows that the housing 41 of the saw head 40 has a swivel mount, into which at least one of the cover segments 80, 90, preferably both cover segments 80, 90, can be swiveled at least sectionally.

In the partially opened or opened sawing position, advantageously the projections of the cover segments 80, 90 in the direction of the axis of rotation overlap at least sectionally in one plane, as illustrated in FIG. 3. This means that only a reduced size of the swivel mount is required inside the housing 41.

FIG. 3 illustrates that a brake unit 48 is accommodated in the housing 41 of the saw head 40. This brake unit 48 is used to act on the saw blade 46. A detection unit is provided, which detects whether a user enters the cutting area 46.1 of the saw blade 46. The brake unit 48 is then activated and the rotation of the saw blade 46 is stopped by the brake unit 48 in a fraction of a second.

Because the movable saw-blade cover 60 is segmented by means of the cover segments 80, 90 and thus only a small installation space is required for swiveling the movable saw-blade cover 60 into the housing 41, the movable saw-blade cover 60 can be swiveled into the housing 41, preferably completely, or the brake unit 48 can be integrated into the housing 41 to save space.

FIG. 7 illustrates that a guide element 91 can be disposed on one of the cover segments 80, 90, preferably on the second cover segment 90, which is used for positively controlled swiveling the cover segment(s) 80, 90.

The guide element 91 can have a sliding section 91.2, which is delimited by a support part 91.2. The support part 91.2 can preferably be detachably connected to the sliding section 91.2.

FIG. 3 illustrates that a guide lever 100 is attached to the saw carriage 30 in a swiveling manner. For this purpose, the guide lever 100 has an articulation link 101, which is attached to a joint of the saw carriage 30. The guide lever 100 can be swiveled about the swivel axis of the joint. This swivel axis extends in parallel to and spaced apart from the miter axis of the miter bearing 34. Opposite from the articulation link 101, the guide lever 100 has a guide mount 102. The sliding section 91.2 of the guide element 91 engages with the guide mount 102. The support 91.1 secures the guide lever 100 to the guide element 91.

In the swung-open rest position of the saw head 40 shown in FIG. 2, the two cover segments 80, 90 are in the closed protective position, in which they protect the saw blade 46 from access. The sliding section 91.2 is located at the end of the guide mount 102 facing away from the articulation link 101. If the saw head 40 is now swiveled about the miter bearing by means of the handle 42, the guide lever 100 is also positively swiveled. Due to the spacing of the miter bearing 34 from the swivel axis of the guide lever 100, a relative motion is caused between the saw head 40 and the guide mount 102. Due to this relative motion, the guide lever 100 continuously pulls the second cover segment 90 to swivel its bearing part 92.1 relative to the support 70. The second cover segment 90 is swiveled into the swivel range of the housing 41 provided for this purpose.

FIG. 6 shows a preferred embodiment, in which a drag connection 120 is implemented between the two cover segments 80, 90. A freewheel 121 may be provided on one of the cover segments 80, 90. A drag element 122 is disposed on the respective other cover segments 80, 90. In the closed protective position shown in FIG. 6, the drag element 122 rests against an end stop 123 of the freewheel 121.

The freewheel 121 can be designed as a slot that is made in one of the two cover segments. The drag element 122 can be designed as a protrusion that engages with this slot.

If the second cover segment 90 is then opened starting from the closed protective position, the drag element 122 at the end stop 123 pulls the first cover segment 80 along with it, such that it is swiveled in conjunction with the second cover segment 90. Accordingly, the first cover segment 80 then unblocks the cutting section.

The saw blade can then plunge into a workpiece that is resting on the support surface 11 of the machine bed 10. During the cutting process, the first cover segment 80 then hits the workpiece beyond the unblocked cutting section. The workpiece can then swivel the first cover segment 80 relative to the second cover segment 90 as the cutting progresses. The drag element 120 then disengages from the end stop 123 and the drag element 122 is adjusted in the freewheel 121. In so doing, the second cover segment 90 swivels into the first cover segment 80. This is shown in FIG. 3.

The adjusting motion of the first cover segment 80 relative to the second cover segment 90 can preferably be delimited by a delimiting element 88 shown in FIG. 5. As soon as the second cover segment 80 is in contact with the delimiting element 88, the first cover segment 80 drags the second cover segment 90 along with it. The sliding section 91.2 can then be adjusted in the guide mount 102, as FIG. 3 shows. FIG. 3 shows the fully open sawing position.

Preferably provision is made for a resetting device 99 shown in FIGS. 5, 6 and 9 to be activated when the two cover segments 80, 90 are moved relative to each other. The resetting device 99 is designed to pretension the two cover segments 80, 90 relative to each other when they are swiveled from the closed protective position shown in FIG. 2 into an open or partially open sawing position.

As FIG. 6 shows, the resetting device can have a return spring 99.2, which acts between the two cover segments 80, 90 to generate the pretension. For instance, the return spring 99.2 may be inserted into a mount 98 of one of the two cover segments 80, 90. In this exemplary embodiment, the mount 98 is formed by the second cover segment 90.

Preferably, the return spring 99.2 can be designed as a coil spring.

For instance, a mandrel 99.1 can be provided on the respective other cover segments 80, 90, which mandrel dips into the installation space encompassed by the coil spring and is supported at one end of the coil spring. The other end of the coil spring is supported on the base of mount 98.

As FIG. 5 shows, the mandrel 99.1 can be disposed on a support element 89 of the assigned cover segment 80, 90.

When the cover segments 80, 90 are moved relative to each other from the closed protective position to the open sawing position, the mandrel 99.1 moves into the mount 98 and compresses the coil spring to bring into a preloaded state.

The resetting device 99 ensures that when the saw head 40 is swiveled from the sawing position (for instance as shown in FIG. 3) towards the starting position shown in FIG. 2, the pretension of the return spring 99.2 moves the cover segments 80, 90 relative to each other in the direction of the closed protective position.

In FIG. 3, for instance, the first cover segment 80 is first swiveled clockwise in the direction of the closed protective position. Due to the force of gravity, the second cover segment 90 also moves into the closed protective position, wherein the sliding section 91.2 is again displaced along the guide mount 102 until it reaches the position shown in FIG. 2. The movable saw-blade cover 60 is then completely returned to the closed protective position.

As FIG. 3 illustrates, the guide lever 100 may have a deflection 103. This deflection 103 is designed to deflect the guide lever 100 around the brake unit 48 in the fully open sawing position to achieve a compact design.

The saw blade 46 can be easily exchanged in the swung-open starting position shown in FIG. 1. For this purpose, a tool is guided through the lead-through 81.1 of the bearing piece 81 of the first cover segment 80 and inserted into a tool holder 45.5.1 of the fastening element 45.5. The tool can be used to loosen the fastening element 45.5. If the fastening element 45.5 is a screw, it can be unscrewed from the threaded mount of the drive shaft 47.1. Because the lead-through 81.1 is sufficiently dimensioned, the fastening element 45.5 can be removed through the lead-through 81.1.

A spacer area A for swiveling the two cover segments 80, 90 is formed between the saw-blade support surface 45.1 and the bearing arrangement. It is sufficiently dimensioned to move the saw blade 46 in conjunction with the clamping piece 45.3 in the direction of the axis of rotation until the clamping piece 45.3 is guided out of the recess 45.2. The saw blade 46 can then be guided radially outwards in the spacer area and replaced by a new saw blade 46. To remove the saw blade 46, the movable saw-blade cover 60 can be easily opened by hand, wherein the two cover segments 80, 90 are then swung into the housing 41.

As can be seen from the above explanation, the circular saw has a saw head 40, which forms a saw-blade receptacle 45.6. A saw blade 46 can be interchangeably mounted on the saw head 40 on a rotatable saw-blade holder 45, which can be driven by a drive unit 47. Preferably, a protective saw-blade cover is provided, which blocks access to the saw-blade receptacle 45.6 at least sectionally, wherein the protective saw-blade cover has a movable saw-blade cover 60, which can be adjusted between a closed protective position and an open sawing position relative to the saw head 40 and which is designed and disposed to cover the saw blade 46, which can be mounted in the saw-blade receptacle 45.6, at least sectionally on its circumferential cutting area in the closed protective position. For the purposes of a compact design, provision may be made for the movable saw-blade cover 60 to have a first cover segment 80 and a second cover segment 90, which, in the closed protective position, each cover a partial area of the saw-blade receptacle 45.6, and for these two cover segments 70, 80 to be movable relative to each other and relative to the saw head 40.

1-14. (canceled)

15. A circular saw, comprising:
a saw head;
a drive unit including a drive shaft, the drive shaft having an axis of rotation;
a shaft bearing rotatably mounting the drive shaft on the saw head;
a saw-blade holder mounted on the drive shaft and configured to interchangeably mount a saw blade on the saw-blade holder;
a saw-blade receptacle configured to receive the saw blade, the saw-blade receptacle being defined between an inner receptacle face and an outer receptacle face spaced apart in a direction of the axis of rotation;
a protective saw-blade cover configured to at least partially block access to the saw-blade receptacle and the saw blade, the protective saw-blade cover including a movable saw-blade cover portion; and
a protective-cover bearing providing a swivel mounting of the movable saw-blade cover portion relative to the saw head such that the movable saw-blade cover portion can be swiveled between a closed protective position and an open sawing position relative to the saw head, the movable saw-blade cover portion being configured to at least partially cover a circumferential cutting area of the saw blade in the closed protective position;
wherein the saw-blade holder is disposed between the protective-cover bearing and the shaft bearing.

16. The circular saw of claim 15, wherein:
the saw head includes a support which supports the protective-cover bearing, the support being at least partially spaced apart from the outer receptacle face of the saw-blade receptacle.

17. The circular saw of claim 16, wherein:
the support includes a bearing holder which holds the protective-cover bearing; and
an axis of rotation of the protective-cover bearing is parallel to the axis of rotation of the drive shaft.

18. The circular saw of claim 17, wherein:
the axis of rotation of the protective-cover bearing is co-axial with the axis of rotation of the drive shaft.

19. The circular saw of claim 15, wherein:
a spacer area is defined between the protective-cover bearing and a saw-blade support surface of the saw blade holder, the spacer area being accessible in a direction radial to the axis of rotation of the drive shaft.

20. The circular saw of claim 19, further comprising:
a clamping piece configured to clamp the saw blade to the saw-blade holder, the clamping piece being at least partially received in the spacer area between the protective-cover bearing and the outer receptacle face of the saw-blade receptacle, wherein the saw-blade receptacle is at least in part defined between the saw-blade holder and the clamping piece.

21. The circular saw of claim 15, wherein:
the protective-cover bearing includes a lead-through through which a fastening element can be guided to fasten the saw blade to the saw-blade holder.

22. The circular saw of claim 21, wherein:
the lead-through extends in alignment with the axis of rotation of the drive shaft.

23. The circular saw of claim 15, wherein:
the movable saw-blade cover portion includes a first cover segment and a second cover segment configured to be movable relative to each other; and
in the closed protective position, each of the first and second cover segments cover a partial area of the saw-blade receptacle.

24. The circular saw of claim 23, wherein:
the saw head includes a support; and
the first and second cover segments are each rotatably mounted on the support.

25. The circular saw of claim 24, wherein:
the support includes an annular bearing holder which holds the protective-cover bearing, the first cover segment being mounted on an inner circumference of the annular bearing holder and the second cover segment being mounted on an outer circumference of the annular bearing holder.

26. The circular saw of claim 23, wherein:
the first cover segment includes a guide; and
the second cover segment includes a guide element which interacts with the guide to form a sliding guide configured to guide relative movement between the first and second cover segments.

27. The circular saw of claim 26, further comprising:
a delimiting element configured to delimit relative movement in at least one direction between the first and second cover segments.

28. The circular saw of claim 15, wherein:
the movable saw-blade cover portion is interchangeably connected to the protective-cover bearing.

29. The circular saw of claim 15, wherein:
the movable saw-blade cover portion includes a toothing cover which covers at least a portion of the circumferential cutting area of the saw blade mounted in the saw-blade receptacle.

30. The circular saw of claim 15, wherein:
the movable saw-blade cover portion includes an outer casing covering at least a portion of an outer face of the saw blade mounted in the saw-blade receptacle, the outer face facing away from the saw-blade holder.

31. The circular saw of claim 15, wherein:
the movable saw-blade cover portion includes an inner casing covering at least a portion of an inner face of the saw blade mounted in the saw-blade receptacle, the inner face facing the saw-blade holder.
